(19) United States
(12) Patent Application Publication
(10) Pub. No.: US 2019/0110498 A1
(43) Pub. Date: Apr. 18, 2019

(54) FROZEN DISPENSING MACHINE HEAT TREATMENT SYSTEM AND METHOD

(71) Applicant: CARRIER COMMERCIAL REFRIGERATION, INC., Farmington, CT (US)

(72) Inventor: James J. Minard, Roscoe, IL (US)

(21) Appl. No.: 16/091,185

(22) PCT Filed: Mar. 31, 2017
(86) PCT No.: PCT/US2017/025363

§ 371 Date: Oct. 4, 2018

Related U.S. Application Data
(60) Provisional application No. 62/319,408, filed on Apr. 7, 2016.

(51) Int. Cl. A23G 9/30; A23G 9/28

(52) U.S. Cl. CPC A23G 9/30; A23G 9/281

(57) ABSTRACT

A frozen food dispensing machine includes a product storage portion including a first volume of product and a freezing portion operably connected to the product storage portion. A dispensing portion is operably connected to the freezing portion to dispense a frozen food product and a conductive heater is located at a heater location of the frozen food dispensing machine to heat a second volume of product in the frozen food dispensing machine. A method of performing a heat treatment cycle on a volume of product in a frozen food dispensing machine includes defining a heat treatment circuit including the freezing portion, heating the volume of product to a heat treatment temperature within a first time duration via a conductive heater located at the freezing portion and holding the volume of material at the heat treatment temperature for a second time duration.

### CROSS-REFERENCE TO RELATED APPLICATIONS

This application claims priority from PCT Application No. PCT/US2017/025363, filed on Mar. 31, 2017, which claimed priority from U.S. Provisional Application No. 62/319,408, filed on Apr. 7, 2016, the entirety of which are both hereby fully incorporated by reference herein.

### BACKGROUND

The subject matter disclosed herein relates to frozen food product dispensing machines. More specifically, the present disclosure relates to heat treatment of frozen food product dispensing machines.

In a typical frozen food dispensing machine, such as a frozen dessert dispenser, product or product mix, typically in a liquid state is delivered to the machine. The bag is opened, and the product or mix is emptied from the bag into a storage hopper portion of the machine. The hopper stores the product and refrigerates it, without freezing the product. To dispense, the product is flowed from the hopper into a freezing cylinder where it is frozen, then to a dispensing portion where it is dispensed as frozen food. To ensure clean or sanitary conditions of the dispensing machine and the frozen food itself, the machine is either emptied, cleaned and sanitized or sanitized using a heat-treating cycle at a selected interval, usually once per day. Emptying the machine results in considerable waste of product, which is disposed from the machine. The possibility exists of potential contamination or spillage of product emptied into the hopper once the sanitizing steps are complete.

Two methodologies currently are utilized to ensure that the dispensed product is safe to consume. The first includes a periodic heat treatment of the entire machine, including product storage bins, transport lines, freezing cylinder and dispensing portion, including the product therein. This is a large volume of material and product to bring up to heat treatment temperature, which subsequently takes a considerable amount of time and energy. The other method involves periodically draining the entire machine and manually cleaning it. This is labor and time intensive, and also costly since the drained product is discarded.

### SUMMARY

In one embodiment, a frozen food dispensing machine includes a product storage portion including a first volume of product and a freezing portion operably connected to the product storage portion. A dispensing portion is operably connected to the freezing portion to dispense a frozen food product and a conductive heater is located at a heater location of the frozen food dispensing machine to heat a second volume of product in the frozen food dispensing machine.

Additionally or alternatively, in this or other embodiments the heater location is a freezing vessel of the freezing portion.

Additionally or alternatively, in this or other embodiments the heater location is one or more of a product delivery line or a recirculation line.

Additionally or alternatively, in this or other embodiments the conductive heater includes a heating element connected to a voltage source via one or more electrical leads.

Additionally or alternatively, in this or other embodiments a heat exchanger at least partially surrounds the heater location, the heat exchanger including a plurality of heat exchanger passages.

Additionally or alternatively, in this or other embodiments the conductive heater is located in contact with the heat exchanger.

Additionally or alternatively, in this or other embodiments the conductive heater is located in contact with one or more of a heat exchanger supply line or a heat exchanger return line.

Additionally or alternatively, in this or other embodiments the conductive heater is configured to heat the second volume of product to a heat treatment temperature.

Additionally or alternatively, in this or other embodiments the heat treatment temperature is at least 150 degrees Fahrenheit.

In another embodiment, a freezing portion of a frozen food dispensing machine includes a freezing vessel configured to freeze a flow of product therethrough and a conductive heater located at the freezing vessel to selectably heat the flow of product to a heat treatment temperature.

Additionally or alternatively, in this or other embodiments the conductive heater includes a heating element connected to a voltage source via one or more electrical leads.

Additionally or alternatively, in this or other embodiments the conductive heater is in direct contact with the freezing vessel.

Additionally or alternatively, in this or other embodiments a heat exchanger at least partially surrounds the freezing vessel, the heat exchanger including a plurality of heat exchanger passages.

Additionally or alternatively, in this or other embodiments the conductive heater is in direct contact with the heat exchanger.

Additionally or alternatively, in this or other embodiments the conductive heater is located in contact with one or more of a heat exchanger supply line or a heat exchanger return line.

Additionally or alternatively, in this or other embodiments the heat exchanger is a microchannel heat exchanger.

Additionally or alternatively, in this or other embodiments the heat treatment temperature is at least 150 degrees Fahrenheit.

In yet another embodiment, a method of performing a heat treatment cycle on a volume of product in a frozen food dispensing machine includes defining a heat treatment circuit including the freezing portion, heating the volume of product to a heat treatment temperature within a first time duration via a conductive heater located at the freezing portion and holding the volume of material at the heat treatment temperature for a second time duration.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is schematic view of an embodiment of a frozen food dispensing machine configured for dispensing operation;

FIG. 2 is a schematic view of an embodiment of a frozen food dispensing machine configured for heat treatment operation;

FIG. 3 is another schematic view of an embodiment of a frozen food dispensing machine;

FIG. 4 is a perspective view of an embodiment of a freezing cylinder of a frozen food dispensing machine;

FIG. 5 is a schematic view of a conductive heater location in an embodiment of a frozen food dispensing machine;

FIG. 6 is a cross-sectional view of an embodiment of a freezing cylinder of a frozen food dispensing machine.

### DETAILED DESCRIPTION

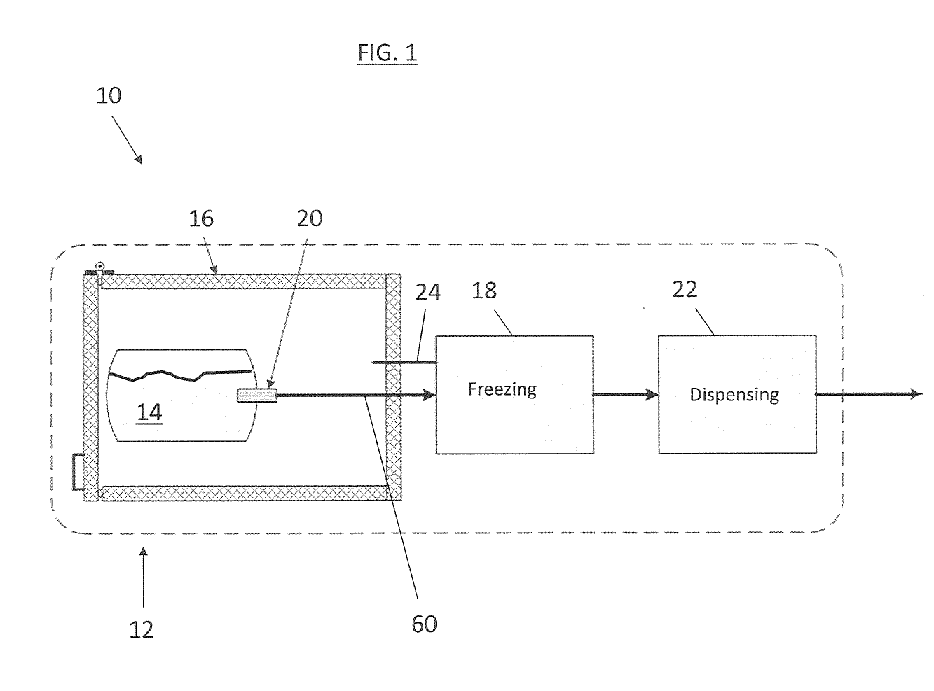

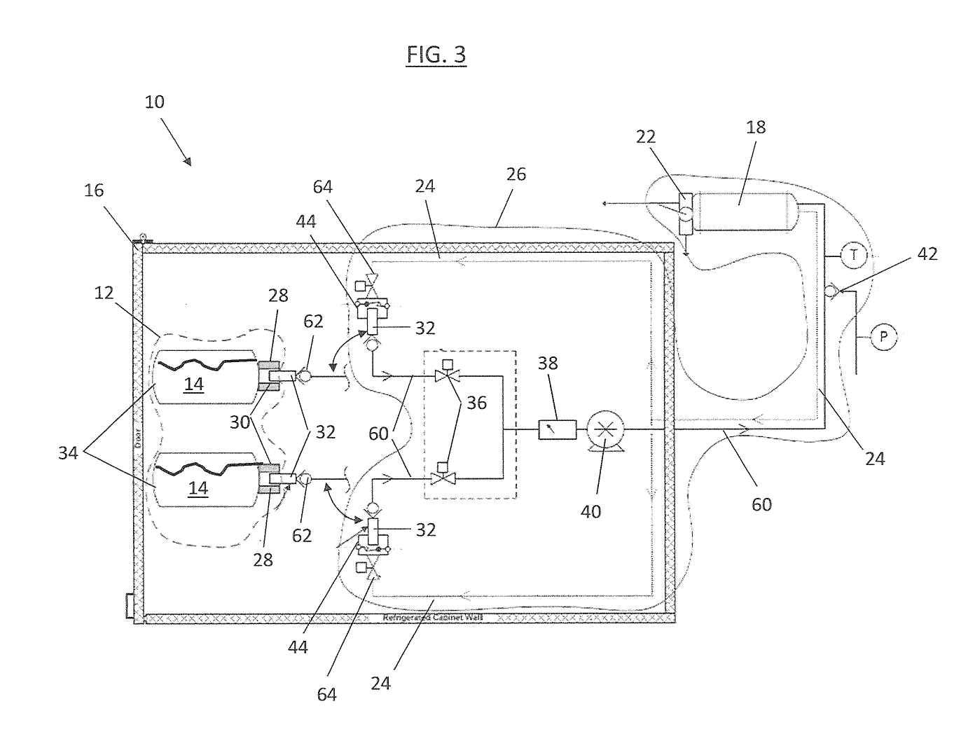

In FIG. 1 is shown a schematic of a frozen food dispensing machine (hereinafter “machine”) 10 configured for dispensing operation. The machine 10 includes a product storage section 12, where a volume of liquid product 14 is stored for use by the machine 10. The product storage section 12 includes a storage compartment 16, which in some embodiments is refrigerated to about 41 degrees Fahrenheit or other temperature, while in other embodiments the storage compartment 16 is maintained at about ambient temperature. The volume of product 14 is stored in a container, for example, a bag or a bin and is connected to a freezing cylinder 18 via a fitting 20. Shown best in FIG. 3, a product bag 34 is equipped with a fitment 28 that includes a self-closing seal 30 that prevents flow from the bag 34 unless the fitting 20 is connected to the product bag 34. Referring again to FIG. 1, the liquid product 14 is frozen at the freezing cylinder 18 and conveyed to a dispensing portion 22 for dispensing of frozen product into a container, such as a cup or a cone (not shown).

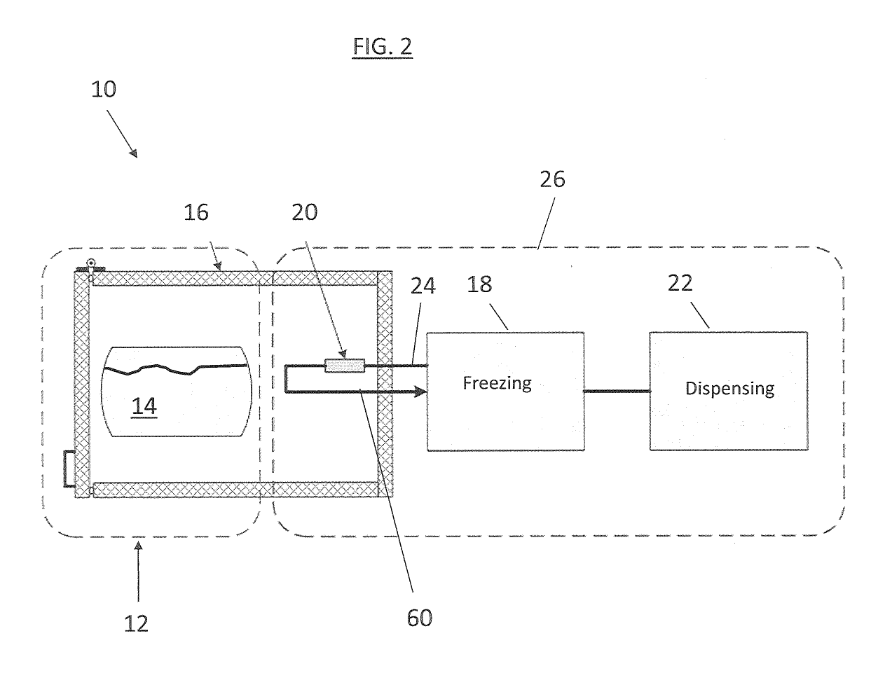

Referring now to FIG. 2, to ensure the product is safe for consumption, the machine 10 is periodically cycled through a heat treatment operation. The machine 10 utilizes a unique method to reduce the heat treated volume and thus reduce the time and energy utilized for a heat treatment cycle. Before initiating heat treatment, the fitting is disconnected from the product 14 and connected to a recirculation line 24. The product 14 is isolated from the remainder of the machine 10, and connecting the fitting 20 to the recirculation line 24 closes a heat treat circuit 26 with the freezing cylinder 18 and the dispensing portion 22. In some embodiments, the recirculation line 24 is connected to the freezing cylinder 18, while in other embodiments the recirculation line is connected to the dispensing portion 22. In addition, the recirculation line 24 may be permanently connected to the machine 10, or it may be a separate part connected to the machine 10, for heat treatment.

The product in the heat treat circuit 26 is then heated up to a heat treat temperature, in some embodiments about 150 degrees Fahrenheit, for a selected duration of time to accomplish the heat treatment. In some embodiments, the product is heated to the heat treatment temperature within 90 minutes or less, and will hold at the heat treat temperature for at least 30 minutes. After heat treatment is completed, the product in the heat treat circuit is then cooled to operating temperature and the fitting 20 is disconnected from the recirculation line 24 and reconnected to the product 14 for resumption of normal operation of the machine 10. Embodiments of this system and method will be described in more detail below. To heat the product in the heat treat circuit 26, a heater disposed at, for example, the freezing cylinder 18 (discussed below) may be utilized. Alternatively, the heater may be located at another portion of the heat treat circuit 26, or the heat treat circuit may be heated by, for example, a heat wrap around lines of the heat treat circuit 26. In still other embodiments, the heat treat circuit 26 may direct product through a heater box (not shown) to heat the product.

Referring now to FIG. 3, another exemplary embodiment is shown. The machine 10 includes a storage compartment 16 that includes product 14 stored in two product bags 34. As stated above, the product 14 may alternatively be stored in a bin, bottle or other container. Further, while two product bags 34 are illustrated, other quantities may be utilized depending on capacity and use of the storage compartment 16. For example, other embodiments may include 1, 3, 4 or 6 or more product bags 34. In some embodiments, each product bag 34 has a capacity of about 10 liters, but one skilled in the art will readily appreciate that other sizes may be utilized. The probe 32 includes a one-way or check valve 62 that prevents inflow of material or contaminants into the product bag 14. The probe 32 is configured such that product 14 flow is in one direction only, out of product bag 34. The product bag 34 is equipped with fitment 28 that includes self-closing seal 30 that prevents flow from the product bag 34 unless the probe 32 is inserted into the product bag 34.

During normal dispensing operation of the machine 10, a probe 32 is connected to the fitment 28 to allow product 14 to flow from the product bag 34. The probe 32 is connected to, or is an end portion of, a product delivery line 60. The product 14 flows through the probe 32, along the product delivery line 60, and in some embodiments through a changeover valve 36, and then in some embodiments past a switch 38 to detect flow from two or more product bags 34. The product 14 is urged from the product bag 34 by a pump 40 located downstream of the switch 38. Downstream of the pump 40, the product 14 flow exits the storage compartment 16. While in the embodiment shown, the pump 40 is located inside the refrigerated compartment, in other embodiments the pump 40 may be located outside of the storage compartment 16.

From the pump 40, the product 14 flow continues along the product delivery line 60 toward the freezing cylinder 18. Before reaching the freezing cylinder 18, air is injected into the product 14 flow via an air injection valve 42. Once frozen at the freezing cylinder 18, the product 14 is dispensed at the dispenser 22. Air may be injected at any location into the product at any location between the probe 32 and the dispensing portion 22.

Periodically, in some embodiments once per day, the machine 10 undergoes the heat treat cycle. To configure the machine 10 for the heat treat cycle, the probes 32 are disconnected from the fitments 28. Each probe 32 and a corresponding recirculation port 44 of the recirculation line 24 may be sanitized, then each probe 32 is then installed to the corresponding recirculation port 44 of the recirculation line 24. Once the probes 32 are installed to the recirculation ports 44, the valve coupling 64 opens, one or more of the changeover valves 36 open, and the pump 40 is started to circulate product 14 through a heat treat circuit 26, defined from the pump 40 through the product delivery line 60, through the freezing cylinder 18, from the freezing cylinder 18 through the recirculation line 24 and through the recirculation port 44/probe 32 interface and back to the pump 40.

To perform the heat treat, the product 14 flowing through the heat treat circuit 26 is heated from the operational temperature of 41 degrees Fahrenheit to the heat treat temperature of 150 degrees Fahrenheit or higher, within 90 minutes or less, and will hold at the heat treat temperature for at least 30 minutes. Once the heating and hold portions of the heat treat cycle, the product flowing through the heat treat circuit 26 is cooled from the heat treat temperature back to the operational temperature in a time span of 120 minutes or less. In some embodiments, the cooling is aided by activating the freezing cylinder 18.

To return the machine 10 to normal operation once the product 14 is cooled, the pump 40 is stopped. The probes 32 are disconnected from the recirculation ports 44, the valve coupling 64 closes, and both the probes 32 and the fitments 28 are sanitized, and each probe 32 is then connected to a corresponding fitment 28.

Disconnecting the probes 32 from the fitments 28 prior to the heat treat operation isolates the product bags 34 from the heat treat circuit 26 thus greatly reducing a volume of product 14 that is heat treated, and as a consequence reducing the time and energy necessary for the heat and hold portions of the heat treat cycle. Because the product 14 is stored in the product bag 34 with the check valve 62 preventing flow from the probe 32 into the product bag 34, there is no need to heat treat the product 14 inside the product bag 34.

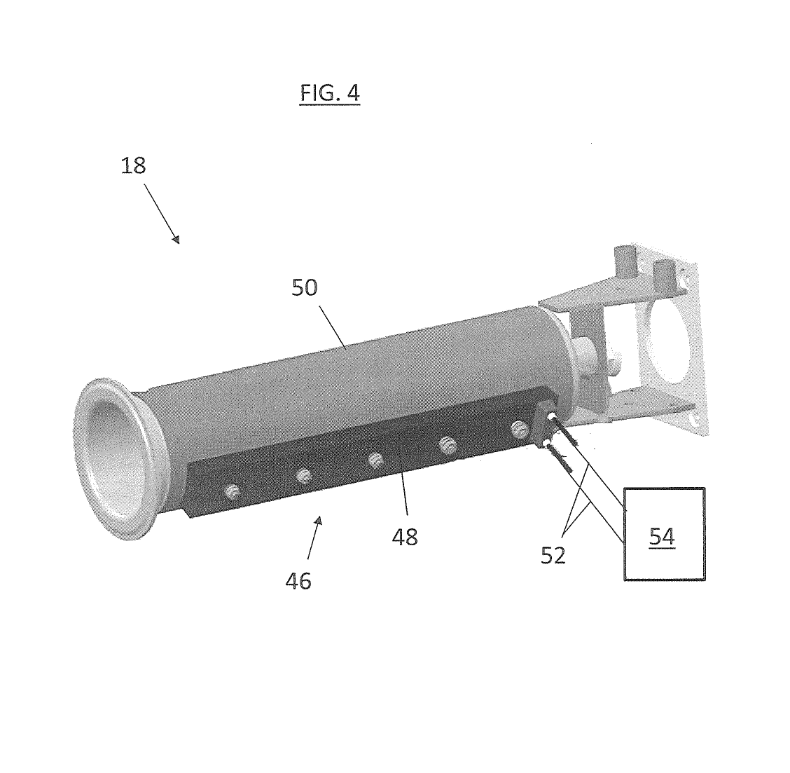

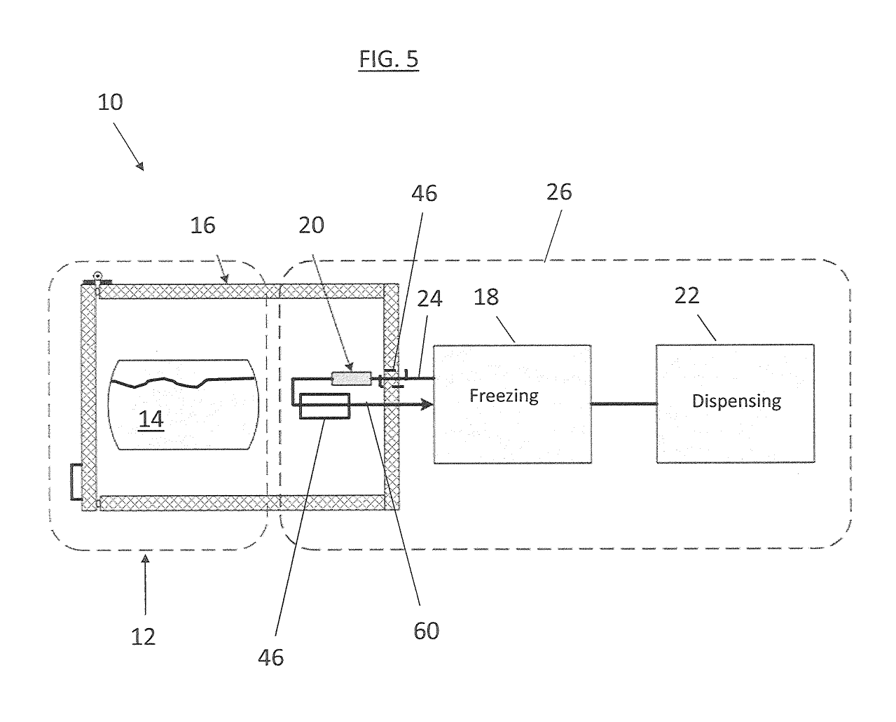

Referring now to FIG. 4, the product 14 flow in the heat treat circuit 26 is heated by a heater located at, for example, the freezing cylinder 18. In some embodiments, the heater is a conductive heater 46 fixed to an outer wall of the freezing cylinder 18. The conductive heater 46 utilizes a heating element 48 in contact with a freezing cylinder vessel 50, to conductively heat the freezing cylinder vessel 50 and thus heat the product 14 flowing through the freezing cylinder 18. In some embodiment a thermal mastic or graphite gasket (not shown) is located between the heating element 48 and the freezing cylinder vessel 50. The heating element 48 is connected to electrical leads 52, and when a voltage is applied to the electrical leads 52 from a voltage source 54, the heating element 48 heats, thus heating the freezing cylinder vessel 50. In other embodiments, such as shown in FIG. 5, the conductive heater 46 may be disposed at other locations of the machine 10, such as at the product delivery line 60, the recirculation line 24, or at an entrance or exit of the freezing cylinder 18.

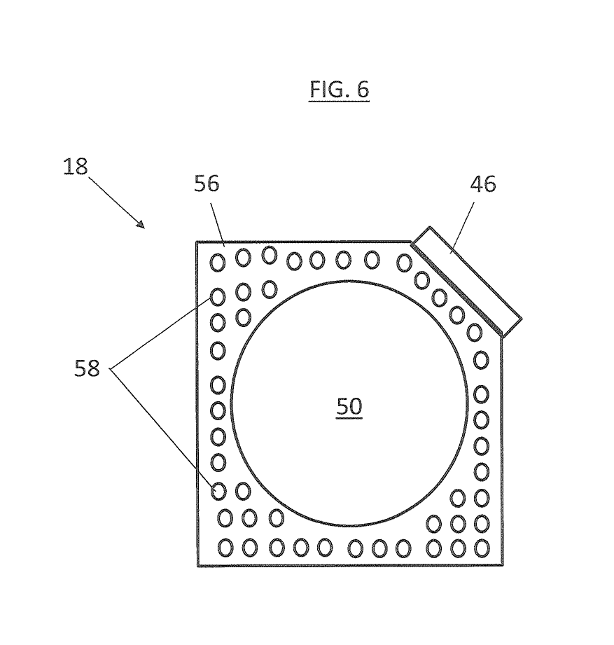

In some embodiments, such as shown in FIG. 6, the conductive heater 46 is used in conjunction with a heat exchanger, for example, a micro-channel heat exchanger (MCHX) 56 wrapped at least partially around the freezing cylinder vessel 50. The MCHX 56 includes a plurality of micro-channels 58 in which a heat transfer medium is located. When energized, the heating element 46 heats the MCHX 56, which in turn heats the freezing cylinder vessel 50. Utilizing the MCHX 56 in conjunction with the conductive heater 46 has the capability of distributing the heating effects of the conductive heater 46 over an increased circumferential area of the freezing cylinder vessel 50 to more quickly and more evenly heat the product 14 flowing through the freezing cylinder vessel 50 during the heat treatment cycle. In some embodiments, the conductive heater 46 heats the freezing cylinder vessel 50 to a freezing cylinder temperature greater than the heat treatment temperature prior to circulating the product through the heat treat circuit 26. In some embodiments, the freezing cylinder temperature is about 175 degrees Fahrenheit. This allows the product flowing therethrough to be quickly heated to the heat treatment temperature. While in some embodiments, the conductive heater 46 is located at a heat exchanger body of the MCHX 56, in other embodiments, the conductive heater 46 is located at one or more of a MCHX supply line or an MCHX return line.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions or equivalent arrangements not heretofore described, but which are commensurate in spirit and/or scope. Additionally, while various embodiments have been described, it is to be understood that aspects of the present disclosure may include only some of the described embodiments. Accordingly, the present disclosure is not to be seen as limited by the foregoing description, but is only limited by the scope of the appended claims.

1. A frozen food dispensing machine, comprising:
a product storage portion including a first volume of product;
a freezing portion operably connected to the product storage portion;
a dispensing portion operably connected to the freezing portion to dispense a frozen food product; and
a conductive heater disposed at a heater location of the frozen food dispensing machine to heat a second volume of product in the frozen food dispensing machine.

2. The frozen food dispensing machine of claim 1, wherein the heater location is a freezing vessel of the freezing portion.

3. The frozen food dispensing machine of claim 1, wherein the heater location is one or more of a product delivery line or a recirculation line.

4. The frozen food dispensing machine of any of claims 1-3, wherein the conductive heater includes a heating element connected to a voltage source via one or more electrical leads.

5. The frozen food dispensing machine of any of claims 1-4, wherein a heat exchanger at least partially surrounds the heater location, the heat exchanger including a plurality of heat exchanger passages.

6. The frozen food dispensing machine of claim 5, wherein the conductive heater is disposed in contact with the heat exchanger.

7. The frozen food dispensing machine of claim 5, wherein the conductive heater is disposed in contact with one or more of a heat exchanger supply line or a heat exchanger return line.

8. The frozen food dispensing machine of any of claims 1-7, wherein the conductive heater is configured to heat the second volume of product to a heat treatment temperature.

9. The frozen food dispensing machine of claim 8, wherein the heat treatment temperature is at least 150 degrees Fahrenheit.

10. A freezing portion of a frozen food dispensing machine, comprising:
a freezing vessel configured to freeze a flow of product therethrough; and
a conductive heater disposed at the freezing vessel to selectably heat the flow of product to a heat treatment temperature.

11. The freezing portion of claim 10, wherein the conductive heater includes a heating element connected to a voltage source via one or more electrical leads.

12. The freezing portion of claim 10 or 11, wherein the conductive heater is in direct contact with the freezing vessel.

13. The freezing portion of any of claims 10-12, further comprising a heat exchanger at least partially surrounding the freezing vessel, the heat exchanger including a plurality of heat exchanger passages.

14. The freezing portion of claim 13, wherein the conductive heater is in direct contact with the heat exchanger.

15. The freezing portion of claim 13, wherein the conductive heater is disposed in contact with one or more of a heat exchanger supply line or a heat exchanger return line.

16. The freezing portion of any of claims 13-15, wherein the heat exchanger is a microchannel heat exchanger.

17. The freezing portion of any of claims 10-16, wherein the heat treatment temperature is at least 150 degrees Fahrenheit.

18. A method of performing a heat treatment cycle on a volume of product in a frozen food dispensing machine, comprising:
defining a heat treatment circuit including the freezing portion;
heating the volume of product to a heat treatment temperature within a first time duration via a conductive heater disposed at the freezing portion; and
holding the volume of material at the heat treatment temperature for a second time duration.
